(19) United States
(12) Patent Application Publication
(10) Pub. No.: US 2008/0013804 A1
(43) Pub. Date: Jan. 17, 2008

(54) Method and apparatus for recognizing fingerprint by hiding minutiae

(75) Inventors: Dae Sung Moon, Daejeon-city (KR); Ki Young Moon, Daejeon-city (KR); Kyo II Chung, Daejeon-city (KR); Sung Won Sohn, Daejeon-city (KR); Yongwha Chung, Daejeon-city (KR)

Correspondence Address: BLAKELY SOKOLOFF TAYLOR & ZAFMAN, 1279 OAKMEAD PARKWAY, SUNNYVALE, CA, 94085-4040, US

(73) Assignees: Electronics and Telecommunications Research Institute; Korea University Industry and Academy Cooperation Foundation

(21) Appl. No.: 11/607,617

(22) Filed: Nov. 30, 2006

(30) Foreign Application Priority Data
Dec. 9, 2005 (KR) 10-2005-0121036

(51) Int. Cl. G06K 9/00

(52) U.S. Cl. 382/124

(57) ABSTRACT

Provided is a method and apparatus for authenticating a fingerprint by hiding minutiae, securely storing information on the fingerprint, and authenticating the information on the fingerprint in order to prevent the information on the fingerprint from being reused by an attacker who accesses the information on the fingerprint that is stored in a storage unit. The method for recognizing fingerprint by hiding minutiae of a fingerprint adds fake minutiae information to genuine minutiae information, hides fingerprint information using a polynomial, which is generated based on personal intrinsic information, and stores the fingerprint information, thereby securely protecting the fingerprint information from an external attacker, and preventing the fingerprint information accessed by the attacker from being reused since the attacker cannot know the genuine minutiae.

### CROSS-REFERENCE TO RELATED PATENT APPLICATIONS

This application claims the benefit of Korean Patent Application No. 10-2005-0121036, filed on Dec. 9, 2005, in the Korean Intellectual Property Office, the disclosure of which is incorporated herein in its entirety by reference.

### BACKGROUND OF THE INVENTION

1. Field of the Invention

The present invention relates to a method for securely storing information on a fingerprint, authenticating the information on the fingerprint, and recognizing the fingerprint, and more particularly, to a method and apparatus for recognizing a fingerprint by hiding minutiae, securely storing information on the fingerprint, and authenticating the information on the fingerprint in order to prevent the information on the fingerprint from being reused by an attacker who accesses the information on the fingerprint that is stored in a storage unit.

2. Description of the Related Art

Since personal biometric data includes finite pieces of information such as on face, irises, etc., it is difficult to freely change them like passwords or personal identification numbers (PINs) used to access an information system. Further, it is possible to change fingerprint information included on ten fingers, when an attacker accesses registered fingerprint information. Therefore, although the attacker may access the fingerprint information stored in a storage unit, the fingerprint information must be necessarily prevented from being reused by the attacker. This is the main idea of the present invention.

Generally, an authorized user uses a user authentication method using passwords or PINs in order to access the information system. However, passwords or PINs could be acquired by another user or forgotten. To address these problems, user authentication methods using intrinsic biometrics data are increasingly introduced.

A fingerprint is used as biometric data in the present invention. A finger authentication system should have a reasonable installation cost, a high security reliability, be globally used for several years, and use a fingerprint that is authenticated as a single personal intrinsic feature. In particular, its miniaturization is advantageous to mobility and space utility. Owing to the development of networks and the demand for security and private protection, fingerprint authentication technology is one of the most popular image recognition technologies. The fingerprint authentication technology can be used in a wide variety of applications, and requires an authentication confirmation speed not exceeding 0.1 seconds.

However, when an attacker accesses fingerprint information registered with the storage unit of the user authentication system using the fingerprint, unlike passwords, it is difficult to change the fingerprint, causing a serious security problem.

Encryption methods are used to easily and securely store fingerprint information. However, encryption methods must securely and effectively manage encryption keys, and repeatedly perform decryption and encryption operations to encode the fingerprint information registered with the fingerprint authentication system and store the encoded fingerprint information. Therefore, the fingerprint authentication system that searches for the fingerprint information of users cannot be used in a mass storage database.

To address these problems, a non-invertible transform function is used to transform the fingerprint information and compare fingerprints in a transformed space. However, because of a non-linear transform required for the non-invertible transform, and geometrical information losses of the fingerprint information, fingerprints cannot be compared in the inverted space.

As an alternative to the non-invertible transform function, the fingerprint authentication system registers temporarily created fake fingerprint minutiae and genuine fingerprint minutiae of a user. The fake fingerprint minutiae and genuine fingerprint minutiae can be distinguished from each other to authenticate the user. When the user requires authentication and inputs his/her fingerprint, the registered fake fingerprint minutiae and genuine fingerprint minutiae can be easily distinguished from each other. However, when another user requests authentication, the registered fake fingerprint minutiae and genuine fingerprint minutiae cannot be easily distinguished from each other. Therefore, although another user accesses the registered fingerprint information including the fake fingerprint minutiae and genuine fingerprint minutiae, the registered fingerprint information cannot be reused to access the fingerprint authentication system. Also, it may not be possible to obtain a single fingerprint image due to the location of a finger, a pressure of the finger applied to a sensor, the rotation of the finger, etc. An alignment of fingerprints that modifies such an error is indispensable to the fingerprint authentication system. However, when the fake fingerprint minutiae are added to the genuine fingerprint minutiae to securely store the fingerprint information, the user cannot perform the alignment which is indispensable to the fingerprint authentication system. Therefore, the alignment of the fingerprints cannot be automatically performed in the fingerprint authentication system.

### SUMMARY OF THE INVENTION

The present invention provides a method and apparatus for adding user's genuine fingerprint minutiae to fake fingerprint minutiae, hiding user's fingerprint information using a polynomial, generated based on personal intrinsic information, and storing the fingerprint information, thereby securely protecting the user's fingerprint information stored in a storage unit from an external attacker, securely managing an encryption key using the fingerprint information when the encryption key is used as intrinsic information for generating the polynomial, and particularly, comparing two fingerprints without aligning the fingerprints using a fingerprint table since a conventional fingerprint authentication method cannot align the two fingerprints when the fake fingerprint information is added

According to an aspect of the present invention, there is provided a method for recognizing a fingerprint by hiding minutiae, the method comprising: (a) generating a polynomial based on intrinsic information including a user's private key; extracting at least one genuine minutia from a fingerprint image; generating at least one fake minutia for hiding the genuine minutiae; forming a first data structure by substituting the genuine minutiae for the polynomial, forming a second data structure by generating a value for the fake minutiae different from a value obtained from the polynomial of the genuine minutiae, and generating registration minutiae in which the genuine minutiae are hidden; and registering a table including the registration minutiae.

According to another aspect of the present invention, there is provided a fingerprint recognition method of extracting genuine minutiae from a fingerprint image, generating fake minutiae, substituting the fake minutiae for a polynomial, which is generated based on intrinsic information, and using a registration table including registration minutiae in which the genuine minutiae are hidden, the method comprising: (a) extracting minutiae from an authentication fingerprint image and generating an authentication table to be compared with the registration table based on the minutiae; (b) comparing the registration table with the authentication table and selecting at least one pair of matched minutiae; (c) correcting an error of wrongly selected minutiae from the at least one pair of matched minutiae; (d) restoring a polynomial generated for the registration based on the corrected minutiae; and (e) if first intrinsic information extracted based on the restored polynomial is matched to second intrinsic information generated for the registration, authenticating two fingerprints as the same fingerprint.

According to another aspect of the present invention, there is provided a fingerprint recognition apparatus, comprising: a first minutiae extractor extracting a first minutia from a fingerprint to be registered; a minutiae protector forming registration minutiae by generating a second minutia, generating a first polynomial as first intrinsic information including a user's private key, and combining the first and second minutiae with the first polynomial, and; a database storing a table including the registration minutiae; a second minutiae extractor extracting minutiae from a fingerprint to be authenticated; a minutiae transformer generating an authentication table using a third minutia that is an output of the second minutiae extractor, comparing a table registered with the database and the authentication table, and selecting pairs of matched minutiae; and a fingerprint matching unit restoring a second polynomial based on the pairs of the minutiae, extracting second intrinsic information, and verifying whether the second intrinsic information is matched to the first intrinsic information.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional fingerprint authentication system;

FIG. 2 is a block diagram of a device for authenticating a registration fingerprint image by hiding minutiae according to an embodiment of the present invention in order to address a problem of the conventional fingerprint authentication system;

FIG. 3 is a block diagram of a minutiae protector illustrated in FIG. 2;

FIG. 4 is a block diagram of a minutiae transformer illustrated in FIG. 2;

FIG. 5 is a block diagram of a fingerprint matching unit illustrated in FIG. 2;

FIG. 6 is a flowchart of a fingerprint registration method that is a part of a method for authenticating fingerprint by hiding minutiae according to an embodiment of the present invention;

FIG. 7 is a flowchart of a fingerprint authentication method that is a part of the method for authenticating fingerprint by hiding minutiae according to an embodiment of the present invention;

FIG. 8A is a registration fingerprint image;

FIG. 8B is an authentication fingerprint image;

FIG. 9 illustrates an operation of generating a polynomial using intrinsic information according to an embodiment of the present invention;

FIG. 10A illustrates an operation of generating fake minutiae according to an embodiment of the present invention;

FIG. 10B illustrates a relationship between genuine minutiae and fake minutiae according to an embodiment of the present invention;

FIG. 10C is a table illustrating hidden genuine minutiae according to an embodiment of the present invention;

FIG. 11 illustrates a data structure by generating the registration minutiae according to an embodiment of the present invention;

FIG. 12 illustrates registration minutiae according to an embodiment of the present invention;

FIG. 13 illustrates geometrically transformed registration minutiae using information on a minutia m1 according to an embodiment of the present invention;

FIG. 14 illustrates the generation of a registration fingerprint table using the registration minutiae illustrated in FIG. 12 according to an embodiment of the present invention;

FIG. 15 illustrates authentication minutiae according to an embodiment of the present invention;

FIG. 16 illustrates geometrically transformed authentication minutiae using information on a minutia n2 according to an embodiment of the present invention;

FIG. 17 illustrates the geometrically transformed authentication minutiae reflected on the registration fingerprint table illustrated in FIG. 14 according to an embodiment of the present invention;

FIG. 18 illustrates registration minutiae geometrically transformed to an actual distance between minutiae m1 and m2; and

FIG. 19 illustrates registration minutiae geometrically transformed to a unit distance between the minutiae m1 and m2.

### DETAILED DESCRIPTION OF THE INVENTION

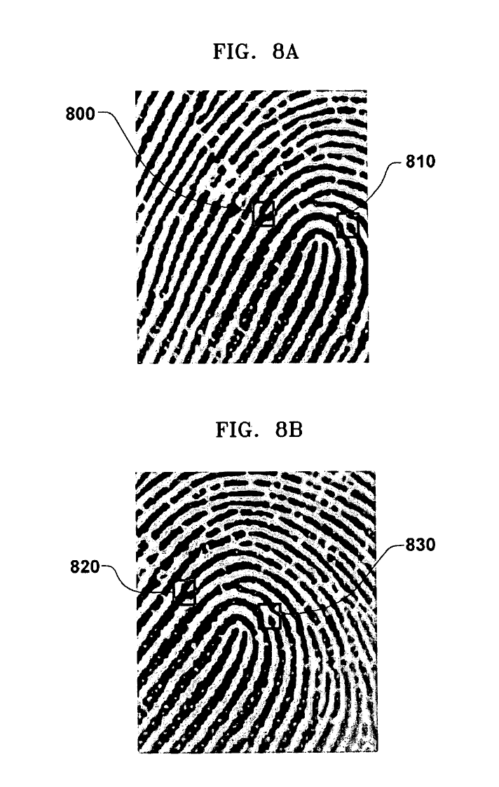

The present invention will now be described more fully with reference to the accompanying drawings, in which exemplary embodiments of the invention are shown. A fingerprint recognition system uses fingerprint feature information, including an ending point 810 where a ridge ends in a fingerprint image, and a bifurcation point 800, where the ridge is bifurcated into two ridges, as illustrated in FIGS. 8A and 8B. Minutiae extracted from the fingerprint feature information includes a coordinate of the minutiae, a direction of the minutiae, and type information on the minutiae, and is expressed as (x,y,θ,type). The fingerprint recognition system refers to the fingerprint features as minutiae.

FIG. 1 is a block diagram of a conventional fingerprint authentication system. Referring to FIG. 1, a registration fingerprint minutiae extractor 110 extracts minutiae from a preprocessed registration fingerprint image, and is stored in a database 120. An authentication fingerprint minutiae extractor 130 extracts minutiae from a preprocessed fingerprint image for user authentication. A fingerprint comparator 140 measures a similarity between the minutiae extracted by the authentication fingerprint minutiae extractor 130 and the minutiae of the registration fingerprint stored in the storaging unit 120 and transfers a matching result to the fingerprint authentication system. At this time, an attacker can access a user's minutiae information stored in the database 120. In this case, if the minutiae information is stored in the database 120 without any protective device, an unauthorized user can access the fingerprint authentication system, since the minutiae information is reused via the input of the fingerprint comparator 140.

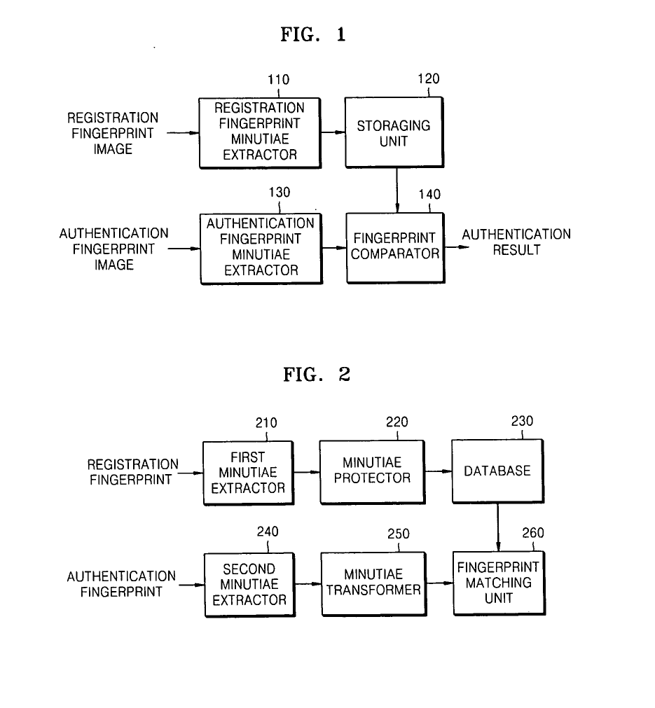

FIG. 2 is a block diagram of a device for authenticating a registration fingerprint image by hiding minutiae according to an embodiment of the present invention in order to address the problem of the conventional fingerprint authentication system. Referring to FIG. 2, a first minutiae extractor 210 extracts minutiae from a user's preprocessed registration fingerprint image. When the extracted minutiae of the registration fingerprint image are stored in a database 230, an attacker can access the minutiae and can reuse the minutiae as described with reference to FIG. 1. To address this problem, in the current embodiment of the present invention, a minutiae protector 220 transforms the minutiae and stores the transformed minutiae in the database 230 in order to prevent the minutiae accessed by the attacker from being reused. A second minutiae extractor 240 extracts minutiae from a preprocessed authentication fingerprint image. A fingerprint matching unit 260 measures a similarity between the minutiae extracted by the second minutiae extractor 240 and the minutiae of the registration fingerprint image stored in the database 230 and determines whether both minutiae are matched to each other. Since the minutiae protector 220 transforms the minutiae extracted by the first minutiae extractor 210 and the database 230 stores the transformed minutiae to protect the minutiae of a user's fingerprint, it is impossible to compare results between the second minutiae extractor 240 and the minutiae protector 220 directly.

Therefore, a minutiae transformer 250 transforms the minutiae extracted by the second minutiae extractor 240 in the same manner as performed by the minutiae protector 220 so that the fingerprint matching unit 260 can compare the minutiae of the registration fingerprint stored in the database 230 and the minutiae transformed by the minutiae transformer 250. A result of the minutiae transformer 250 is transferred to a system (not shown) that uses the result. Further, the minutiae transformer 250 uses a non-invertible transform to transform the minutiae and stores them in the database 230 in order to prevent information on the minutiae of the registration fingerprint from being accessed by an attacker. Therefore, the minutiae protector 220 uses a non-invertible transform function to transform the minutiae of the registration fingerprint. The fingerprint matching unit 260 does not use the minutiae extracted by the first minutiae extractor 210, but the minutiae transformed by the minutiae protector 220.

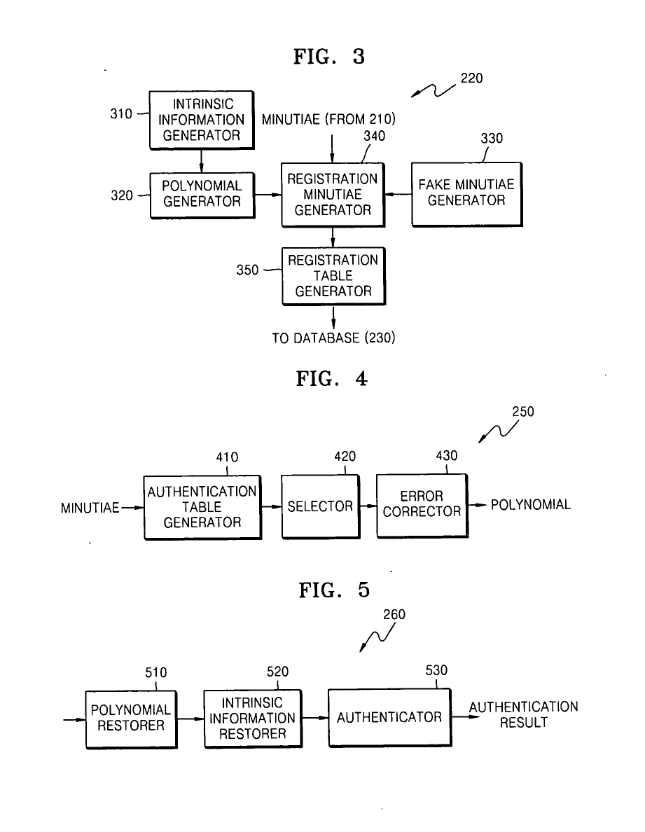

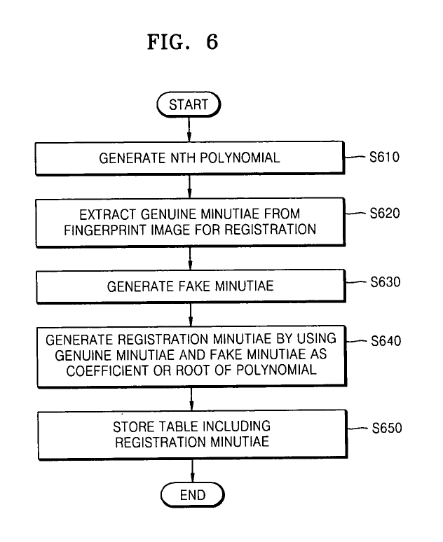

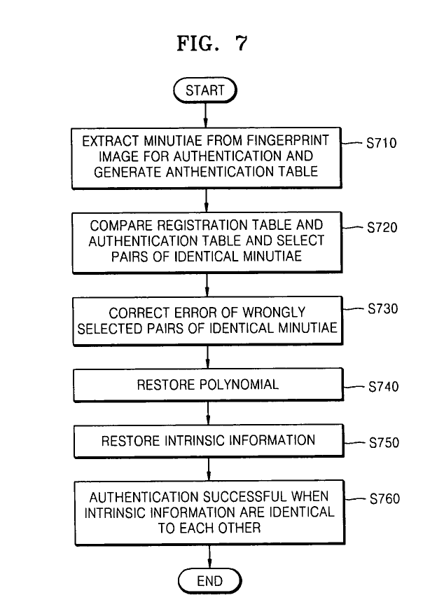

FIG. 3 is a block diagram of the minutiae protector 220 illustrated in FIG. 2. FIG. 4 is a block diagram of the minutiae transformer 250 illustrated in FIG. 2. FIG. 5 is a block diagram of the fingerprint matching unit 260 illustrated in FIG. 2. FIG. 6 is a flowchart of a fingerprint registration method that is a part of a method for authenticating fingerprint by hiding minutiae according to an embodiment of the present invention. FIG. 7 is a flowchart of a fingerprint authentication method that is a part of the fingerprint authentication method for hiding minutiae according to an embodiment of the present invention.

The first minutiae extractor 210 extracts genuine minutiae from the preprocessed registration fingerprint image obtained by registering a fingerprint in Operation S620. The present invention uses fake minutiae and a polynomial to protect the genuine minutiae. To this end, an intrinsic information generator 310 generates intrinsic information for generating the polynomial used to protect the minutiae. A registration system can arbitrarily generate the intrinsic information. A user's private key used in an encryption system can be the intrinsic information. The polynomial (f( )) for protecting the minutiae is generated using the intrinsic information as a coefficient or a root of the polynomial (f( )) in Operation S610. A result obtained by substituting information on an x coordinate among the genuine minutiae for the polynomial (f( )) is added to information (x,y,θ,type) on the genuine minutiae to store (x,y,θ,type, f(x)). A fake minutiae generator 330 arbitrarily generates fake minutiae in the fingerprint authentication system in order to protect the information (x,y,θ,type, f(x)) on the genuine minutiae from an attacker. Since the fake minutiae is in the form of (x′,y′,θ′,type′,β), and β≠f(x′) unlike the genuine minutiae information, x′ is not a root of the polynomial (f( )) (Operation 630).

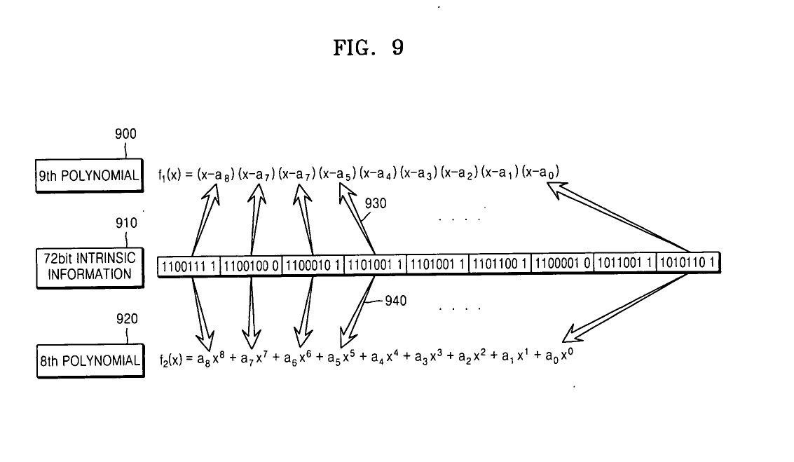

The genuine minutiae (x,y,θ,type, f(x)) and the fake minutiae (x′,y′,θ′,type′,β) are mixed to generate registration minutiae. At this time, to authenticate user's fingerprint, the genuine minutiae are separated from the registration minutiae, which is a mixture of the genuine and fake minutiae, the polynomial (f( )), which is the same as that generated in Operation S610, is restored using the genuine minutiae, and the intrinsic information is obtained from the restored polynomial (f( )). The fingerprint recognition system must compare fingerprints to separate the genuine minutiae from the registration minutiae. However, whenever the same fingerprint is input into a fingerprint input device, a coordinate value of minutiae of the fingerprint is calculated and the minutiae are rotated, as illustrated in FIGS. 8A and 8B. FIG. 8A is a registration fingerprint image. FIG. 8B is an authentication fingerprint image. A bifurcation point 800 illustrated in FIG. 8A and a bifurcation point 820 illustrated in FIG. 8B are a pair of the same minutiae. An ending point 810 illustrated in FIG. 8A and an ending point 830 illustrated in FIG. 8B are a pair of the same minutiae. Since the pairs of the same minutiae have different absolute coordinate values and direction according to times when the minutiae are input, an alignment process that translates and rotates two fingerprints by a change of amount of difference is necessarily required. However, since the fake minutiae are added to the genuine minutiae in Operation S640, two fingerprints cannot be aligned using only the two genuine minutiae of the user obtained during the fingerprint registration and authentication process. Therefore, a registration fingerprint table is generated to pre-align the two fingerprints during the fingerprint registration process and the registration minutiae are stored in the database 230 in Operation S650. A polynomial generator 320 will now be described with reference to FIG. 9. FIG. 9 illustrates an operation of generating a polynomial using intrinsic information 910 according to an embodiment of the present invention. Referring to FIG. 9, if a 72-bit intrinsic information generator 310 generates the intrinsic information 910, a polynomial generator 320 can generate an 8^{th} degree polynomial f₂(x) 920 and a 9^{th} degree polynomial f₁(x) 900. The 72-bit intrinsic information 910 is divided into 8 bits so that 9 blocks are generated. If the 8-bit 9 blocks are used as a root of a polynomial in SOperation S930, the polynomial generator 320 can generate the 9^{th} degree polynomial f₁(x) 900. If the 8-bit 9 blocks are used as a coefficient of the polynomial in Operation S940), the polynomial generator 320 can generate the 8^{th} degree polynomial f₂(x) 920. A degree of the polynomial is first determined based on the number of the genuine fingerprint minutiae and a security level. The intrinsic information 910 is divided into blocks as required. The blocks are used as the root or coefficient of the polynomial. An x or y coordinate value in the fingerprint minutiae can be used as a parameter of the polynomial. When the x coordinate value, i.e., a width of a fingerprint image, is used as the variable of the polynomial, since a value obtained from the polynomial cannot exceed the width of the fingerprint image, the polynomial performs a Galois field operation of GF(x). When the x and y coordinate values. i.e., the width and height of the fingerprint image, are used as the variable of the polynomial, the polynomial also performs a Galois field operation of GF(x²), because the width and height of the fingerprint image have similar values. Further, a constituent suitable for a data structure including a variety of fingerprint minutiae used in a fingerprint recognition algorithm can be used as the variable of the polynomial.

FIG. 11 illustrates a data structure for generating the registration minutiae according to an embodiment of the present invention. An operation of a fake minutiae generator 330 will now be described with reference to FIG. 11. As described above, minutiae of a fingerprint includes x and y coordinates, a direction, and type information, and are expressed as (x,y,74 ,type). When the first minutiae extractor 210 extracts the genuine minutiae from the same fingerprint image, the genuine minutiae are not extracted at the exact same location due to noise of the fingerprint input device, and so an error caused by processing the fingerprint image. Because of the error caused by extracting the genuine minutiae, when matched pairs of minutiae are selected by comparing the minutiae of the registration fingerprint and the minutiae of the authentication fingerprint, a tolerance is experimentally designated. Two pairs of minutiae which are within the tolerance range are regarded as being matched. The number of the pairs of minutiae is used to determine a similarity between two fingerprints. Therefore, if the tolerance range is not designated when the fake minutiae generator 330 generates the fake minutiae, the fake minutiae can be wrongly determined as the genuine minutiae. In the current embodiment, the fake minutiae generator 330 generates the fake minutiae outside the tolerance range of the x and y coordinates and direction designated by the fingerprint recognition system. Referring to FIG. 11, white minutiae 1100 are the genuine minutiae, and black minutiae 1110 are the fake minutiae. In the genuine minutiae 1100, minutiae in the ranges of a tolerance Δd 1130 of the x and y coordinates and a tolerance Δθ 1140 of the direction are regarded as matched pairs of minutiae. That is, since minutiae in a dot-lined square 1150 within the tolerance range of an angle are regarded as being matched, the fake minutiae 1110 have the x and y coordinates and direction outside the tolerance ranges. As for information on types, when the genuine minutiae 1100 are ending points, the fake minutiae 1110 are bifurcation points, and when genuine minutiae 1100 are bifurcation points, the fake minutiae 1110 are ending points.

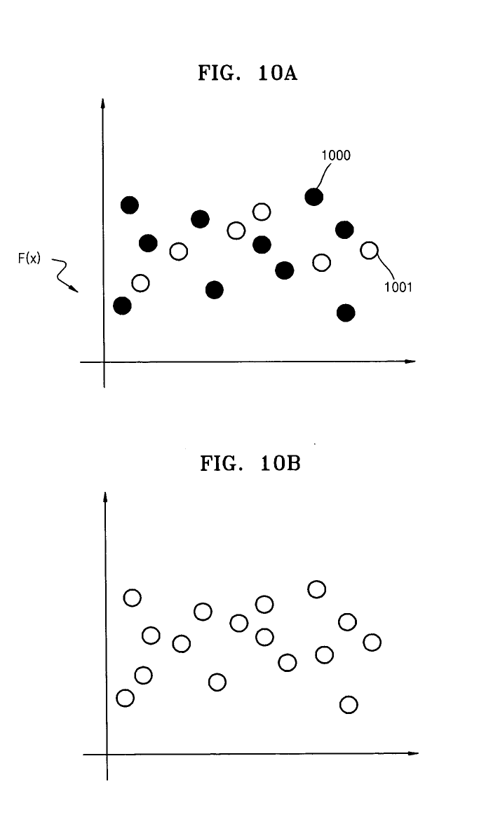

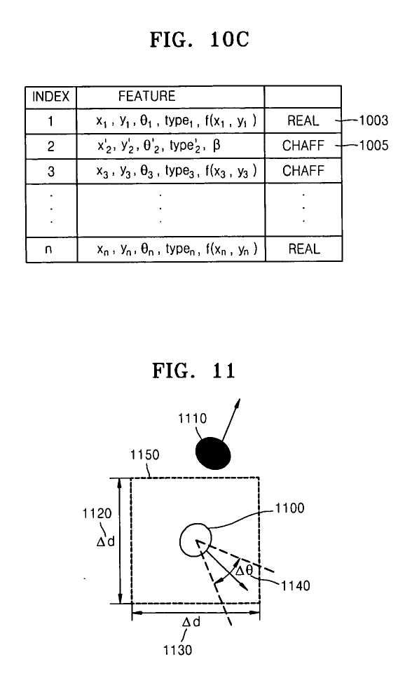

FIG. 10A illustrates an operation of generating fake minutiae according to an embodiment of the present invention. FIG. 10B illustrates a relationship between genuine minutiae and fake minutiae according to an embodiment of the present invention. FIG. 10C is a table illustrating hidden genuine minutiae according to an embodiment of the present invention. Referring to FIGS. 10A, 10B, and 10C, an operation of a registration minutiae generator 340 that combines the fake minutiae generated by the fake minutiae generator 330 and the genuine minutiae extracted by the first minutiae extractor 210 and generates the registration minutiae in which the fake minutiae are hidden will now be described. Referring to FIG. 10A, it is assumed that a polynomial generator 3209 generates a polynomial F(x). White points 1001 that exist on the polynomial F(x) are the genuine minutiae extracted by the first minutiae extractor 210. Black points 1000 that do not exist on the polynomial F(x) are the fake minutiae generated by the fake minutiae generator 330. As mentioned above, the genuine minutiae includes (x,y,θ,type, f(x)) 1003, the fake minutiae includes (x′,y′,θ′,type′,β) 1005, and β≠f(x′). Therefore, an x coordinate value of the fake minutiae does not exist on the polynomial F(x).

Referring to FIG. 10C, since the genuine minutiae and fake minutiae are registered via the registration minutiae generator 340, and an attacker does not know information on the polynomial generated by the polynomial generator 320, the attacker cannot distinguish the genuine minutiae from the fake minutiae if the attacker does not know the user's registration fingerprint. A registration table generator 350 uses minutiae information illustrated in FIG. 10C. The white points 1001 that exist on the F(x) illustrated in FIG. 10A are exactly separated from white points illustrated in FIG. 10B and pairs of minutiae matched to the white points 1001 are selected in order to restore the polynomial F(x) using various polynomial restoration methods such as simultaneous equations. The same polynomial as F(x) cannot be restored when pairs of minutiae identical to the black points 1000 do not exist on the F(x). Therefore, since information on the while points 1001 that exist on F(x) can be obtained via the user's fingerprint, the genuine minutiae can be securely hidden from another person.

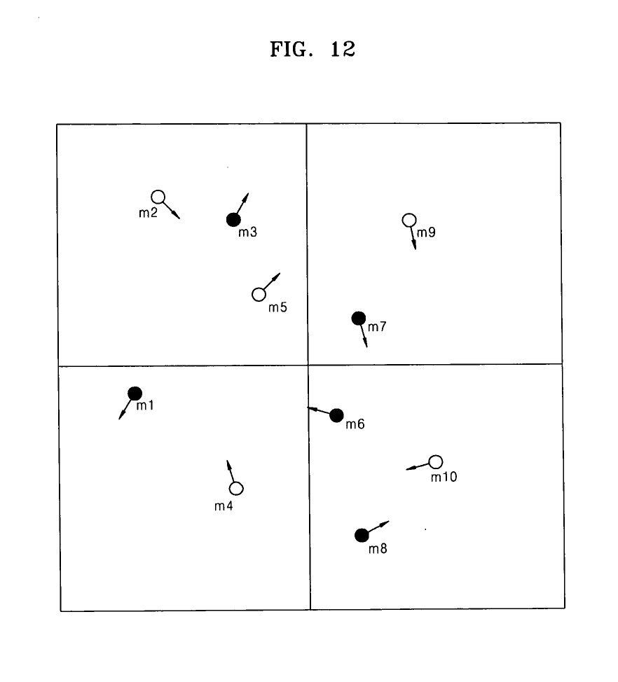

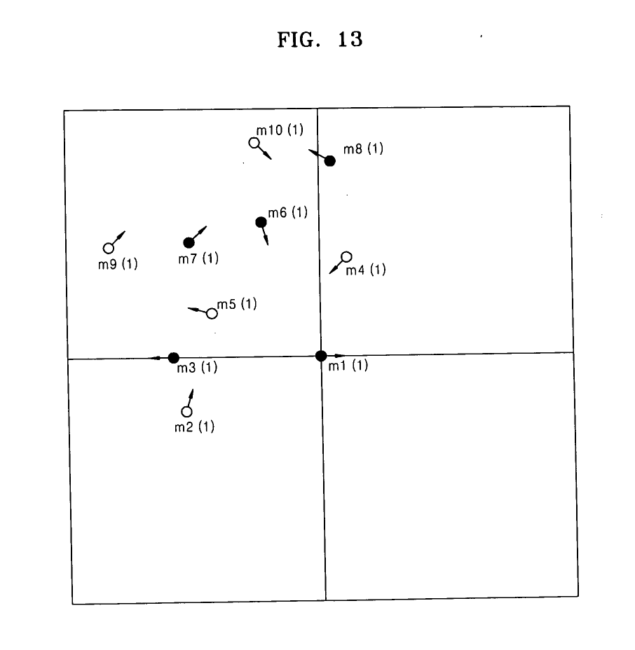

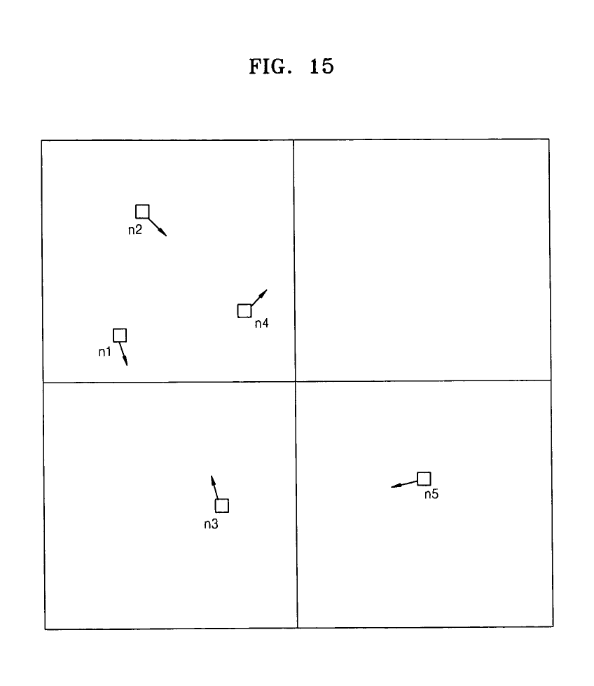

A pre-alignment of the registration table generator 350 illustrated in FIG. 3 and an authentication table generator 410 illustrated in FIG. 4 will now be described with reference to FIGS. 12 through 16. FIG. 12 illustrates information on the genuine minutiae extracted from the first minutiae extractor 210 and the fake minutiae generated by the fake minutiae generator 330. Referring to FIG. 12, white minutiae are the genuine minutiae and black minutiae are the fake minutiae. For descriptive convenience, five genuine minutiae and five fake minutiae are illustrated; however, the number of the fake minutiae is quite more than the number of the genuine minutiae in order to make it difficult to select the genuine minutiae. FIG. 15 illustrates authentication minutiae. A typical fingerprint authentication system modifies angles and coordinates between the registration minutiae illustrated in FIG. 12 and the authentication minutiae illustrated in FIG. 15, obtains pairs of matched minutiae from a set of registration and authentication minutiae, and measures similarities between the pairs of matched minutiae. However, the fake minutiae are added to the genuine minutiae as illustrated in FIG. 12. Therefore, since a modification parameter can be calculated only by separating the genuine minutiae from the fake minutiae, the pairs of matched minutiae cannot be obtained. In this regard, the present invention provides a method of obtaining the pairs of matched minutiae without separating the genuine minutiae from the fake minutiae by pre-aligning information on the genuine registration minutiae and fake registration minutiae as described in FIG. 13. FIG. 13 illustrates a geometrical transform of the registration minutiae illustrated in FIG. 12 using information on a minutia m1 according to an embodiment of the present invention. Referring to FIG. 13, an image plane is transformed to a reference plane in order to pre-align the registration minutiae. For example, a reference axis in which a coordinate of the minutia m1 is a starting point of the reference plane and an arrow of the minutia m1 on the X-axis has 0° is established. The location and direction of the minutiae other than the minutia m1 are m2(1), m3(1), m4(1), m5(1), m6(1), m7(1), m8(1), m9(1), and m10(1), which are transform values based on the reference plane generated by the minutia m1. In FIG. 13, a registration fingerprint table of the minutia m1 is generated by transforming other minutiae based on the minutia m1 in Operation S650.

The registration fingerprint table generated by the registration table generator 350 stores information on coordinate locations of transformed minutiae and information on direction and type of the transformed minutiae.

The operation is repeatedly performed for minutiae m2 through m10.

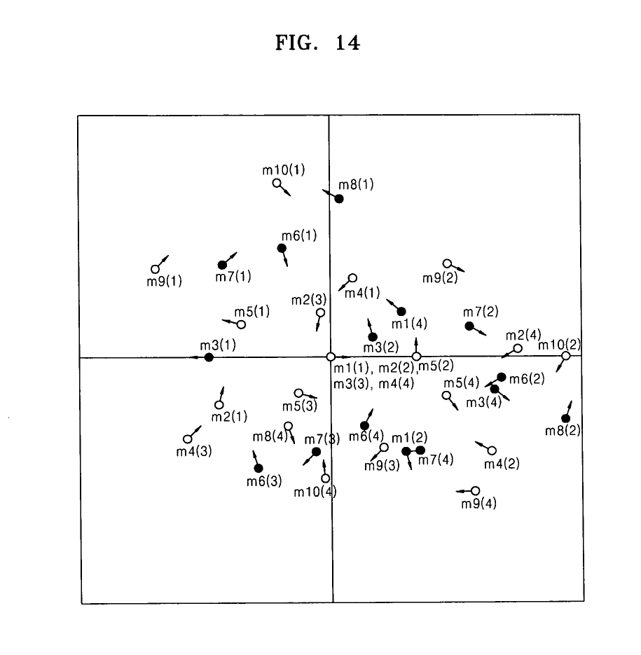

FIG. 14 illustrates the generation of registration fingerprint tables of the minutiae m1 through m4. Referring to FIG. 14, registration fingerprint tables of all the genuine and fake minutiae are generated and pre-aligned based on available geometrical changes in terms of the rotation and shift of the minutiae generated by the first minutiae extractor 210 and the fake minutiae generator 330. Thus, an excellent recognition performance is obtained without any modification when an authentication fingerprint and a registration fingerprint are compared to obtain pairs of matching minutiae.

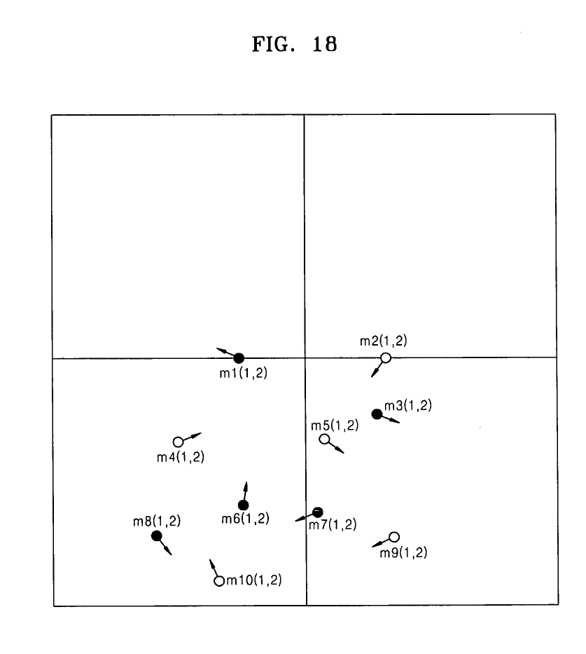

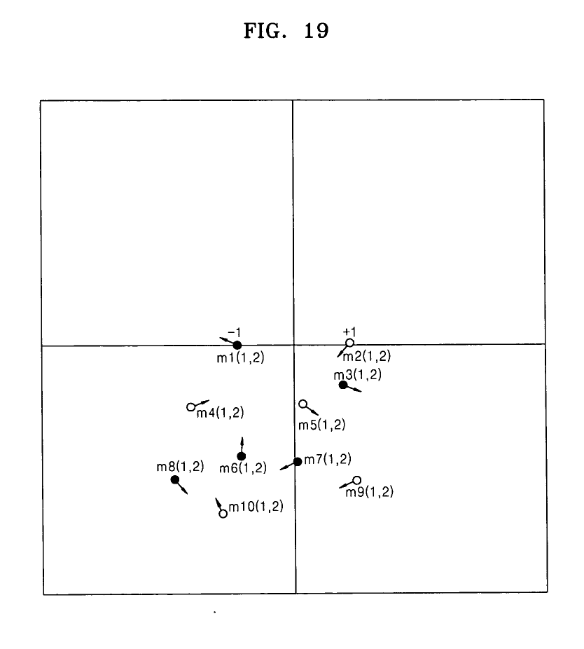

A minutia among the registration minutiae illustrated in FIG. 14 is used as a reference point for pre-aligning the registration minutiae. However, a method of using two minutiae as the reference point will now be described with reference to FIGS. 18 and 19. Referring to FIGS. 18 and 19, a reference plane is established in which a center of two minutiae is a starting point and a reference axis in which a line between the two starting point minutiae has 0° on an X-axis. In FIG. 18, other minutiae are transformed based on the reference plane using the two minutiae m1 and m2. A distance between the two minutiae m1 and m2 is an actual distance in FIG. 18, whereas the distance between the two minutiae m1 and m2 is a unit distance in FIG. 19.

An authentication process will now be described. FIG. 4 is a block diagram of the minutiae transformer 250 and the fingerprint matching unit 260, and FIG. 7 is a flowchart of operations of the minutiae transformer 250 and the fingerprint matching unit 260.

The second minutiae extractor 240 obtains a preprocessed authentication fingerprint image and extracts minutiae from it. The authentication table generator 410 generates an authentication fingerprint table using the minutiae extracted by the second minutiae extractor 240 in Operation S710 in the same manner as Operations S640 and S650 of generating the registration fingerprint table using the registration table generator 350 and thus its detailed description will be skipped. A selector 420 compares the authentication fingerprint table generated by the authentication table generator 410 and the registration fingerprint table stored in the database 230 and selects pairs of minutiae having the same location, direction, and type in Operation S720. The bifurcation point 800 illustrated in FIG. 8A and the bifurcation point 820 illustrated in FIG. 8B, and the ending point 810 illustrated in FIG. 8A and the ending point 830 illustrated in FIG. 8B are pairs of the minutia having the same location, direction, and type.

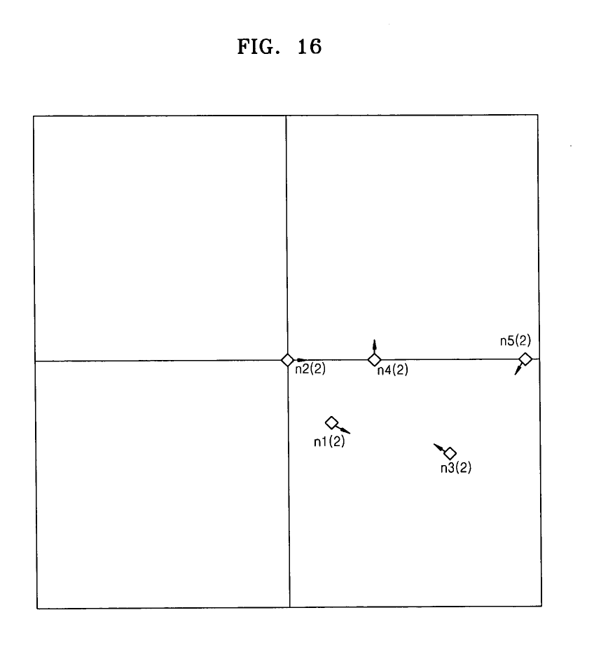

FIGS. 15, 16, and 17 illustrate operations of the authentication table generator 410 and the selector 420. It is assumed that the minutiae n1, n2, n3, n4, and n5 illustrated in FIG. 15 are minutiae extracted by the second minutiae extractor 240 from a user's fingerprint. A fingerprint holder of FIG.15 is the same as that of FIG. 12. FIG. 16 illustrates the authentication fingerprint table in which the minutiae n1(2), n3(2), n4(2), and n5(2) are transformed to the reference plane based on the minutia n2.

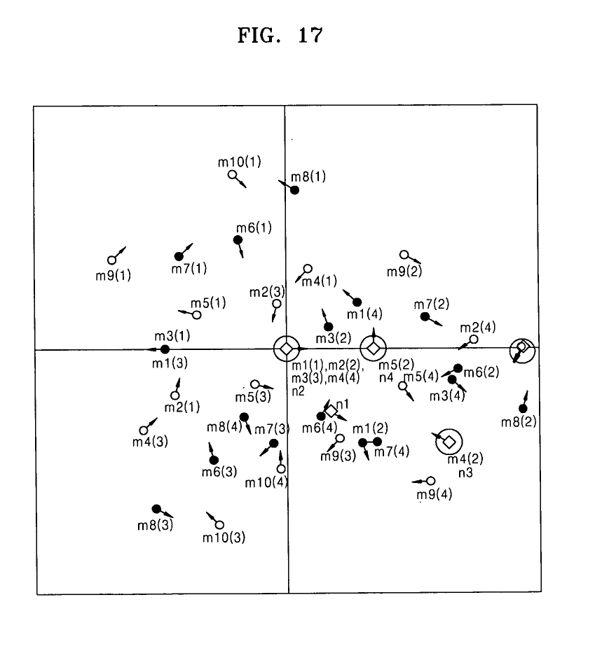

FIG. 17 is obtained by overlapping FIG. 16 with FIG. 14. The selector 420 selects four pairs of minutiae m2(2) and n2(2), m4(2) and n3(2), m5(2) and n4(2), and m10(2) and n5(2) as illustrated in FIG. 17. However, the minutia n1(2) illustrated in FIG. 16 and the genuine minutia m9(2) illustrated in FIG. 14 have no matched minutiae since the results of the fingerprint image obtaining operation and the minutiae extracting operation are not clear.

The authentication fingerprint table of the reference point n2 is compared to the registration fingerprint table or the authentication fingerprint table of all the minutiae extracted by the second minutiae extractor 240 in order to select pairs of matched minutiae. For example, FIG. 16 illustrates the authentication fingerprint table of the reference point n2. The same method is used to generate authentication fingerprint tables of all the minutiae based on the reference points n1, n3, n4, and n5 in order to select pairs of matched minutiae. Also, if the registration table generator 350 generates the reference plane using the two minutiae as illustrated in FIGS. 18 and 19, the authentication table generator 410 must generate the reference plane using two minutiae when generating authentication fingerprint table.

The same polynomial as generated by the polynomial generator 320 must be calculated from the selected pairs of matched minutiae using simultaneous equations. However, some fake minutiae can be selected as pairs of matched minutiae due to errors caused when a fingerprint image is obtained using a fingerprint obtaining device, when minutiae are extracted from the obtained fingerprint image, etc. In this case, the same polynomial as generated by the polynomial generator 320 cannot be restored using simultaneous equations. Therefore, it is necessary to correct an error. To this end, an error corrector 430 corrects an error to exclude fake minutiae from the selected pairs of matched minutiae in Operation S730. A polynomial restorer 510 receives pairs of matched genuine minutiae from the error corrector 430 and restores the same polynomial as generated by the polynomial generator 320 in Operation S740. For example, when the polynomial generated by the polynomial generator 320 is a 5^{th} degree polynomial, more than six pairs of genuine minutiae only are extracted to restore the same polynomial as generated by the polynomial generator 320 using simultaneous equations that input x and f(x) values in the information on the genuine minutiae ((x,y,θ,type, f(x)). However, when the fake minutiae are selected as pairs of matched minutiae, since β≠f(x′) in the information on the minutiae is (x′,y′,θ′,type′,β) as described with reference to the operation of the fake minutiae generator 330, the same polynomial generated by the polynomial generator 320 cannot be restored using simultaneous equations.

An intrinsic information restorer 520 restores intrinsic information generated by the intrinsic information generator using the restored polynomial in Operation S750. If the polynomial generator 320 uses the intrinsic information as a coefficient, the intrinsic information restorer 520 restores the intrinsic information by combining coefficients of the restored polynomial. If the polynomial generator 320 uses the intrinsic information as a root, the intrinsic information restorer 520 restores the intrinsic information by calculating roots of the restored polynomial and combining roots.

When the intrinsic information obtained in Operation S750 is matched to the intrinsic information generated by the intrinsic information generator 310, an authenticator 530 authenticates the intrinsic information as a user's fingerprint in Operation S760.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed network coupled computer systems so that the computer readable code is stored and executed in a distributed fashion.

According to the present invention, a method for recognizing fingerprint by hiding minutiae of a fingerprint adds fake minutiae information to genuine minutiae information, hides fingerprint information using a polynomial generated from personal intrinsic information, and stores the fingerprint information, thereby securely protecting the fingerprint information from an external attacker, and preventing the fingerprint information accessed by the external attacker from being reused since the external attacker cannot know the genuine minutiae.

An encryption key used as intrinsic information for generating a polynomial can be securely managed using the fingerprint information. In particular, a conventional fingerprint recognition method cannot align two fingerprints due to the fake minutiae information. However, a fingerprint table of the present invention makes it possible to compare two fingerprints without an alignment of the two fingerprints despite the fake minutiae information.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method for recognizing a fingerprint by hiding minutiae, the method comprising:
(a) generating a polynomial based on intrinsic information including a user's private key;
(b) extracting at least one genuine minutia from a fingerprint image;
(c) generating at least one fake minutia for hiding the genuine minutiae;
(d) forming a first data structure by substituting the genuine minutiae for the polynomial, forming a second data structure by generating a value for the fake minutiae different from a value obtained from the polynomial of the genuine minutiae, and generating registration minutiae in which the genuine minutiae are hidden; and
(e) registering a table including the registration minutiae.

2. The method of claim 1, wherein operation (a) comprises:
(a1) determining a degree of the polynomial;
(a2) separating the intrinsic information into data blocks consisting of bit numbers suitable for the degree of the polynomial; and
(a3) generating the polynomial by using each of the data blocks of the intrinsic information as coefficients or roots of the polynomial.

3. The method of claim 1, wherein operation (c) comprises:
(c1) determining the number of the fake minutiae;
(c2) generating the fake minutiae having the same second data structure as the first data structure of the genuine minutiae;
(c3) verifying whether the fake minutiae are in a tolerance range required to determine the fake minutiae or the genuine minutiae when a fingerprint is authenticated; and
(c4) if the fake minutiae are within the tolerance range, returning to operation (c2) by the number of the fake minutiae.

4. The method of claim 3, wherein the first data structure includes values on a horizontal ax, values on a vertical ax, angles of directions, and types of the genuine minutiae, and the second data structure includes values on a horizontal ax, values on a vertical ax, angles of directions, and types of the fake minutiae.

5. The method of claim 1, wherein operation (d) comprises:
(d1) substituting information including the coordinates of the genuine minutiae for a parameter of the polynomial;
(d2) updating the first data structure to a third data structure by adding a polynomial value obtained by the substitution;
(d3) updating the second data structure to a fourth data structure by generating a different value from the polynomial value and adding the generated value to the second data structure; and
(d4) generating a data structure of the registration minutiae by combining the third and fourth data structures;

6. The method of claim 1, wherein operation (e) comprises:
(e1) selecting one of the registration minutiae as a reference point;
(e2) generating a first reference plane of the reference point, moving a coordinate of the reference point to a starting point of the first reference plane, and setting an angle of the reference point as 0°;
(e3) forming the table by geometrically correcting the other minutiae by a correction parameter necessary for transforming the reference point to the reference starting point, and obtaining the data structures including locations, directions, types, and polynomial values of the other minutiae; and
(e4) repeating operations (e1), (e2), and (e3) with regard to the other minutiae by selecting each of the registration minutiae as the reference point.

7. The method of claim 6, wherein operation (e1) further comprises:
(e5) selecting two registration minutiae from the registration minutiae, and selecting a second reference plane in which the center of a line between the two selected registration minutiae is a starting point and the line is a reference axis;
(e6) forming the table by obtaining the data structures including the location, directions, types, and polynomial values of the other registration minutiae from the second reference plane; and
(e7) selecting pairs of all the registration minutiae and repeatedly performing operations (e5) and (e6).

8. The method of claim 7, wherein operation (e5) further comprises:
selecting two registration minutiae from the registration minutiae and selecting the second reference plane by setting a distance between the two registration minutiae as a unit distance.

9. A fingerprint recognition method of extracting genuine minutiae from a fingerprint image, generating fake minutiae, substituting the fake minutiae for a polynomial, which is generated based on intrinsic information, and using a registration table including registration minutiae in which the genuine minutiae are hidden, the method comprising:
(a) extracting minutiae from an authentication fingerprint image and generating an authentication table to be compared with the registration table based on the minutiae;
(b) comparing the registration table with the authentication table and selecting at least one pair of matched minutiae;
(c) correcting an error of wrongly selected minutiae from the at least one pair of matched minutiae;
(d) restoring a polynomial generated for the registration based on the corrected minutiae; and
(e) if first intrinsic information extracted based on the restored polynomial is matched to second intrinsic information generated for the registration, authenticating two fingerprints as the same fingerprint.

10. The method of claim 9, wherein operation (a) comprises:
(a1) selecting one of the minutiae as a reference point;
(a2) generating a first reference plane of the reference point, moving a coordinate of the reference point to a starting point of the first reference plane, and setting an angle of the reference point as 0°;
(a3) forming the authentication table by geometrically correcting the other minutiae by a correction parameter necessary for transforming the reference point to the reference starting point, and obtaining a data structure including locations, directions, types, and polynomial values of the other minutiae; and
(a4) repeating operations (a1), (a2), and (a3) with regard to the other minutiae by selecting each of the minutiae as the reference point.

11. The method of claim 10, wherein operation (a1) further comprises:
(a11) selecting two registration minutiae from the registration minutiae, and selecting a second reference plane in which the center of a line between the two selected registration minutiae is a starting point and the line is a reference axis;
(a12) forming the table by obtaining the data structures including the location, directions, types, and polynomial values of the other registration minutiae from the second reference plane; and
(a13) selecting pairs of all the registration minutiae and repeatedly performing operations (a11) and (a12).

12. The method of claim 11, wherein operation (a11) further comprises:
selecting the second reference plane by setting a distance between the two registration minutiae as a unit distance.

13. The method of claim 9, wherein operation (b) comprises:
(b1) selecting a reference plane from the authentication table;
(b2) searching for pairs of minutiae satisfying a tolerance by reflecting the reference plane to the registration table;
(b3) selecting pairs of minutiae having the same reference plane as the reference plane selected in the registration table from the searched pairs of minutiae; and
(b4) performing operations (b1) through (b3) for all the reference planes and selecting a pair of minutiae of the reference plane having the most number.

14. The method of claim 9, wherein, in operation (c), an error is corrected using an error correction code to modify or delete wrongly selected minutiae from the selected minutiae.

15. The method of claim 9, wherein, in operation (d), simultaneous equations that input a variable of the polynomial and a value obtained by substituting intrinsic information for the variable are calculated and restored.

16. The method of claim 9, wherein operation (e) further comprising:
if the number of pairs of matched minutiae is smaller than the degree of the polynomial when the registration table is generated, determining verification as being erroneous or users as being inconsistent and stopping authentication.

17. The method of claim 9, wherein, in operation (e), if the intrinsic information when the registration table is generated is a coefficient of the polynomial, intrinsic information is restored based on a coefficient of the restored polynomial, and if the intrinsic information when the registration table is generated is a root of the polynomial, a root of the restored polynomial is calculated to restore the intrinsic information.

18. A fingerprint recognition apparatus, comprising:
a first minutiae extractor extracting a first minutia from a fingerprint to be registered;
a minutiae protector forming registration minutiae by generating a second minutia, generating a first polynomial as first intrinsic information including a user's private key, and combining the first and second minutiae with the first polynomial, and;
a database storing a table including the registration minutiae;
a second minutiae extractor extracting minutiae from a fingerprint to be authenticated;
a minutiae transformer generating an authentication table using a third minutia that is an output of the second minutiae extractor, comparing a table registered with the database and the authentication table, and selecting pairs of matched minutiae; and
a fingerprint matching unit restoring a second polynomial based on the pairs of the minutiae, extracting second intrinsic information, and verifying whether the second intrinsic information is matched to the first intrinsic information.

19. The apparatus of claim 18, wherein the minutiae protector comprises:
an intrinsic information generator outputting information including a clock signal generated during the operation of the fingerprint recognition apparatus or a user's private key as the intrinsic information;
a polynomial generator dividing the intrinsic information into at least one block in accordance with the degree of the first polynomial, and generating the first polynomial using the at least one block as a coefficient or a root of the first polynomial;
a fake minutiae generator generating the second minutia having the same structure as a first data structure of the first minutia;
a registration minutiae generator generating a data structure of registration minutiae by adding a value obtained by substituting the first minutia for a variable of the first polynomial to the first data structure, and adding a value different from the value for the second minutia; and
a registration table generator forming a table including the geometrical information by setting a reference plane having at least one minutia of the registration minutiae as a reference point and generating geometrical information of the other minutiae.

20. The apparatus of claim 18, wherein the minutiae transformer comprises:
an authentication table generator forming a table including the geometrical information by setting a reference plane having at least one minutia of the third minutiae as a reference point, and generating geometrical information of the other minutiae;
a selector comparing the authentication table with the registration table and searching for pairs of matched minutiae, and outputting the pairs of matched minutiae; and
an error corrector correcting an error of the pairs of matched minutiae using an error correction code and removing the fake minutiae added when the registration table is generated.

21. The apparatus of claim 18, wherein the fingerprint matching unit comprises:
a polynomial restorer restoring the second polynomial by extracting the pairs of matched minutiae based on a degree of the first polynomial, calculating simultaneous equations that input a variable of the pairs and a value obtained by substituting the intrinsic information for the variable;
an intrinsic information restoring the second intrinsic information based on a coefficient or a root of the restored second polynomial; and
an authenticator, determining two fingerprints as being the same user's fingerprint if the first and second intrinsic information are matched to each other.
